(19) United States
(12) Patent Application Publication
(10) Pub. No.: US 2002/0038192 A1
(43) Pub. Date: Mar. 28, 2002

(54) Electrical high-voltage machine, in particular a turbo-generator, and method for measuring a temperature in an electrical high-voltage machine

(76) Inventor: Jurgen Klaar, Neukirchen-Vluyn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/953,727

(22) Filed: Sep. 17, 2001

Related U.S. Application Data
(63) Continuation of application No. PCT/EP00/01951, filed on Mar. 6, 2000.

(30) Foreign Application Priority Data
Mar. 17, 1999 (EP) 99 105 488.3

(51) Int. Cl. G01K 1/00; G01K 5/00

(52) U.S. Cl. 702/130; 702/132

(57) ABSTRACT

The temperature in an electrical high-voltage machine, in particular on a rotor winding or on a stator winding, is measured reliably, simply and at low cost. The sensor or sensors are semiconductor chips which transmit a digital measurement value. A corresponding method is outlined in which the digital measured value is transmitted to an electronics module and from there to an evaluation unit.

### CROSS-REFERENCE TO RELATED APPLICATION

This application is a continuation of copending international application PCT/EP00/01951, filed Mar. 6, 2000, which designated the United States.

### BACKGROUND OF THE INVENTION

1. Field of the Invention

The invention relates to an electrical high-voltage machine, in particular a turbogenerator, having a temperature measurement apparatus for measuring a temperature in the electrical high-voltage machine. The invention also relates to a method of measuring a temperature in an electrical high-voltage machine, and specifically in a turbogenerator.

The significance of a temperature measurement on an electrical winding in an electrical machine is explained in the book “Die Isolierung groβer elektrischer Maschinen” [The Insulation of Large Electrical Machines] by Hartmut Maier, Springer-Verlag, Berlin, Göttingen, Heidelberg, 1962, page 30. There it is explained that in indirectly cooled windings, the so-called natural hot spot, that is to say the point of maximum temperature, in the case of two conductor bars which are arranged one above the other in a slot in a laminated core is located close to the lower edge of the upper conductor bar, in the center of the machine. The temperature there reaches a level up to about 10° C. above the mean copper temperature as can be measured by the increase in resistance. However, the measurement of the winding temperature using, for example, the thermocouples or resistance thermometers which are installed between the upper and the lower conductor bar in order to monitor operation, generally produces measured values that are still considerably lower. This is because the temperature measurement elements between the upper conductor bar and the lower conductor bar are within a temperature field created between these conductor bars and the laminated core and are themselves well away from the conductor bars, so that indication differences of 20° C. or more are possible. When operating electrical machines, these indication differences must be taken into account for correct assessment of the temperature indication from slot thermometers. This means that manufacturers are faced with the task of avoiding strictly localized additional losses, which can lead to the formation of hot spots that are difficult to detect.

### SUMMARY OF THE INVENTION

It is accordingly an object of the invention to provide an electrical high-voltage machine, in particular a turbogenerator, which overcomes the above-mentioned disadvantages of the heretofore-known devices and methods of this general type and wherein temperature measurement is possible reliably and in a simple and low-cost manner, even in areas where access is difficult. It is a further object of the invention to specify a corresponding method.

With the foregoing and other objects in view there is provided, in accordance with the invention, a temperature measurement apparatus for measuring a temperature within a housing of an electrical high-voltage machine, in particular of a turbogenerator. The apparatus comprises a temperature sensor in the form of a semiconductor chip disposed in the housing.

Such a temperature sensor measures a temperature by means of an integrated circuit arranged on a semiconductor crystal. The temperature is in this case wherein by a digital measured value. The invention is based on the surprising knowledge that such a temperature sensor can be used reliably in the extreme environmental conditions in a high-voltage machine. In particular, it has been possible to show by trials that this temperature sensor also withstands the high voltages for long periods. Such a temperature sensor costs little and requires no maintenance. It can also be used in areas of the high-voltage machine where access is difficult. In comparison to other temperature measurement methods which are resistant to high voltages, for example by means of fiber-optic temperature measurement systems, the temperature sensor can be used with considerably less installation complexity and has a considerably longer life. In comparison to infrared measurement systems or radiation pyrometers, which allow surface temperatures to be measured, the temperature sensor has the advantage that it can be fitted directly at the desired measurement point. In contrast, infrared measurement systems or radiation pyrometers always require a minimum separation from live parts, for isolation.

In accordance with an added feature of the invention, an electronics module is electrically connected to the temperature sensor. Preferably, the connection is via a physical distance of not more than one meter. That is, the temperature measurement apparatus preferably has an electronics module, which is electrically connected to the temperature sensor. The electronics module more preferably has a memory for storing measured values which each characterize one temperature. It is thus possible to store a range of temperatures, preferably a time temperature profile. The memory can then, for example, be read at appropriate checking times.

In accordance with an additional feature of the invention, the electronics module has a microprocessor and a timer, and a timing of the storage of the measured values can be controlled by the microprocessor and the timer. That is, the electronics module preferably has a microprocessor and a timer, wherein case the timing of the storage of the measured values can be controlled by the microprocessor and the timer. The electronics module thus allows, for example, a time interval for subsequent temperature measurements to be defined in a simple manner. Furthermore, a start or end time for a temperature measurement can be predetermined in a simple manner.

The electronics module and the temperature sensor are preferably physically separated from one another, preferably by at least 10 cm. This physical separation between the temperature sensor and the electronics module also allows the temperature sensor to be arranged at measurement points where access is difficult or which are critical because of high voltage, without this having any adverse effects on the electronics module. In particular, a maximum temperature, which is critical for the electronics module is generally not critical when selecting the measurement point, due to the physical separation. The electronics module and the temperature sensor are preferably separated from one another by not more than one meter. In particular, this means that signals, which are interchanged between the electronics module and the temperature sensor are qualitatively not significantly adversely affected.

In accordance with another feature of the invention, the electronics module has a transmitting device for non-contacting transmission of signals, in particular by means of infrared radiation. Such non-contacting transmission results, in particular, in isolation between the high-voltage potential at which the temperature measurement is carried out and a ground potential at which the temperature measurement is evaluated. Furthermore, no further transmission means, for example cables, whatsoever are required.

The electronics module preferably has a receiving device for non-contacting reception of signals, in particular by means of infrared radiation.

In accordance with again a preferable feature of the invention, the electronics module has a power supply by means of a solar cell. The electronics module preferably has a power supply by means of inductive generation of electrical power from a magnetic field surrounding the electronics module. If the electronics module is supplied with power from a solar cell or else via stray magnetic fields in the environment, the electronics module can be supplied with power locally and independently. There is thus no need to provide any transmission paths for supplying power, which would lead, in particular, to problems in potential isolation between high-voltages and ground potential.

The turbogenerator has a rotor with an electrical rotor winding, with the temperature sensor preferably being arranged on the rotor, furthermore preferably on the rotor winding. It is particularly difficult to measure temperatures on the rotor or on the rotor winding, since the high rotation speeds result in high centrifugal forces. It has been possible to show in trials that the temperature sensor and the electronics module as well withstand the high mechanical loads resulting from centrifugal forces, even for long periods. In this case, the temperature measured values are transmitted in a suitable manner, for example without any physical contact, as stated above.

At least two temperature measurement apparatuses are preferably provided on the electrical machine, with each temperature measurement apparatus having its own identification unit, by means of which it can be identified, and wherein case each temperature measurement apparatus can be read by a common evaluation unit. Such an identification unit can be stored, for example, as an identification number in a microprocessor in the electronics module. A number of temperature measurement apparatuses can thus be operated with a single evaluation unit, in a simple manner. Transmission of a temperature measured value is combined with the identification number of the respective temperature measurement apparatus, thus ensuring a unique association between the measured temperature and the measurement point.

With the above and other objects in view there is also provided, in accordance with the invention, a method of measuring a temperature in an electrical high-voltage machine, which comprises:

determining a temperature in the electrical high-voltage machine as a digital measured value with a semiconductor chip temperature sensor;

transmitting the digital measured value to an electronics module; and

transmitting the digital measured value from the electronics module to an evaluation unit.

The advantages of such a method correspond to those in the above statements relating to the advantages of the temperature measurement apparatus in an electrical high-voltage machine.

In accordance with a concomitant feature of the invention, the measured value is preferably stored in the electronics module. The measured value is preferably transmitted from the electronics module to the evaluation unit without any physical contact, in particular by means of infrared radiation.

Other features which are considered as characteristic for the invention are set forth in the appended claims.

Although the invention is illustrated and described herein as embodied in an electrical high-voltage machine, in particular a turbo-generator, and method for measuring a temperature in an electrical high-voltage machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block schematic of a temperature measurement apparatus; and

FIG. 2 is a schematic diagram of a turbogenerator with a temperature measurement apparatus.

Identical reference symbols have the same meaning in both figures.

### DESCRIPTION OF THE PREFERRED EMBODIMENTS

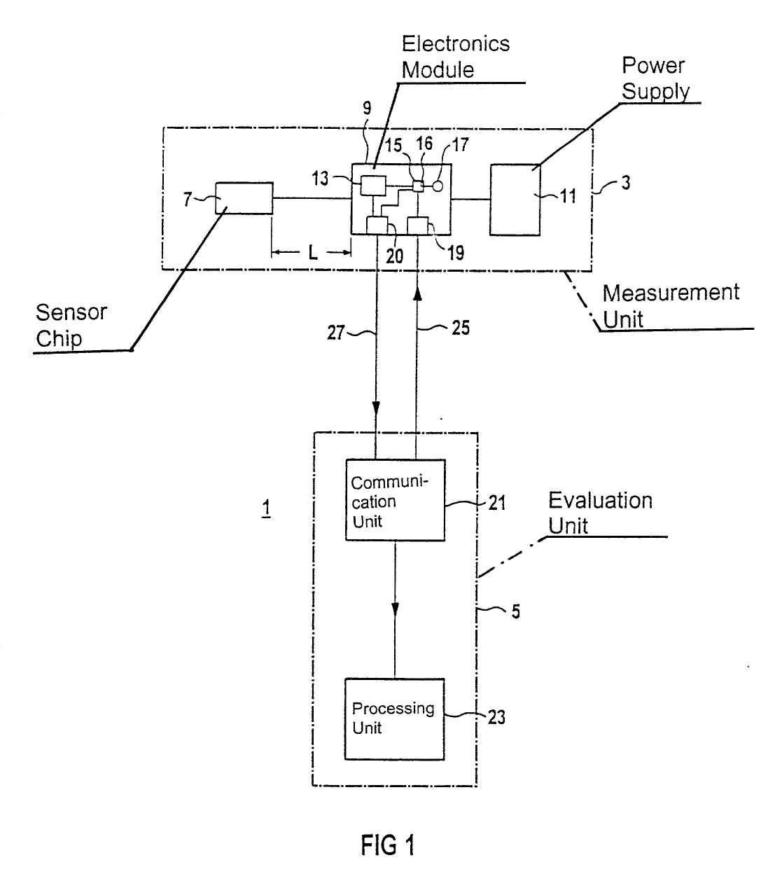

Referring now to the figures of the drawing in detail and first, particularly, to FIG. 1 thereof, there is shown a temperature measurement apparatus 1. The temperature measurement apparatus 1 has a measurement unit 3 and an evaluation unit 5. The measurement unit 3 has a temperature sensor 7, which is in the form of a semiconductor chip. The temperature sensor 7 is electrically connected to an electronics module 9. The electronics module 9 is electrically connected to a power supply unit 11. The electronics module 9 has a memory 13, a microprocessor 15, a timer 17, a receiving unit 19 and a transmitting unit 20. The memory 13 is electrically connected to the microprocessor 15. The microprocessor 15 has an identification unit 16. The microprocessor 15 is connected to the timer 17. The microprocessor 15 is also electrically connected to the receiving unit 19 and to the transmitting unit 20. The evaluation unit 5 has a communication unit 21 and a processing unit 23. The evaluation unit 5 communicates via the communication unit 21 with the electronics module 9 in the measurement unit 3, by means of transmitted signals 25 and received signals 27.

When the temperature measurement apparatus 1 is in use, the temperature sensor 7 measures a local temperature. By way of example, the temperature sensor is arranged on a winding bar in the electrical winding of the stator or rotor of a turbogenerator, and measures its local temperature. This temperature is measured directly as a digital measured value since the temperature sensor 7 is in the form of a semiconductor chip. The measured value is passed on to the electronics module 9. The measured value is stored in the memory 13 in the electronics module 9. The timing for storage of measured values in the memory 13 is controlled via the microprocessor 15 and the timer 17. By way of example, a temperature measured value is stored in the memory 13 once a minute using the microprocessor 15 and the timer 17. The power supply for the temperature measurement by means of the temperature sensor 7 and for controlling and storing the temperature measurement by means of the electronics module 9 is provided by the power supply unit 11. This may, for example, have a battery. However, it may also have a solar cell, by means of which electrical power for supplying the measurement unit 3 is obtained from ambient light. This generation of electrical power in the power supply unit 11 may, however, also be carried out by inductive generation of an electrical voltage by means of stray magnetic fields, which vary with time, in the vicinity of the power supply unit 11.

The temperature measured values measured by the measurement unit 3 are read by the evaluation unit S. This is done by a transmitted signal 25 being transmitted to the receiving unit 19 in the electronics module 9. This results in the memory contents of the memory 13 being checked. The memory contents are transmitted via the transmitting unit 20, as a received signal 27, to the communication unit 21 in the evaluation unit 5. The communication unit 21 transmits the temperature measured values to the processing unit 23 which may, for example, be a personal computer. The temperature measured values can then be displayed by the evaluation unit 5.

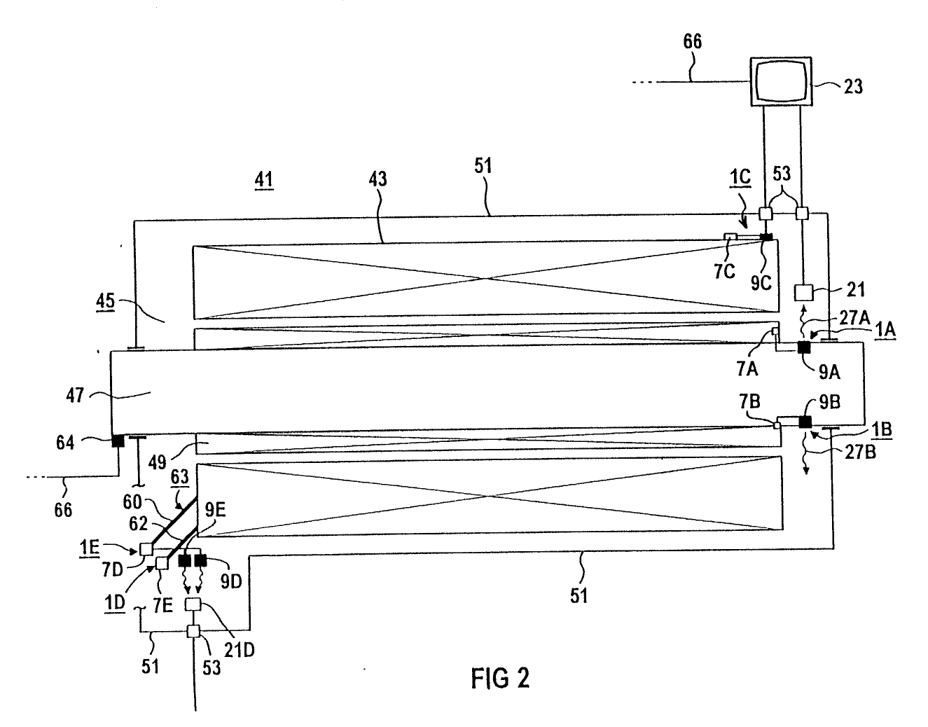

Such a temperature measurement apparatus 1 is used for measuring temperatures in a turbogenerator 41. The following description of that system will now make reference to FIG. 2. FIG. 2 shows a longitudinal section through a turbogenerator 41. The turbogenerator 41 has a stator 43, which comprises a laminated core and an electrical stator winding. The stator 43 surrounds a rotor 45. The rotor 45 has a shaft 47 and an electrical rotor winding 49, which is disposed on the shaft 47.

The stator 43 and the rotor 45 are disposed in a common housing 51.

The turbogenerator 41 has five temperature measurement apparatuses 1A, 1B, 1C, 1D, 1E as shown in FIG. 1. Two temperature measurement apparatuses 1A, 1B are arranged opposite one another on the rotor 45. The respective temperature sensors 7A, 7B are in this case arranged on the rotor winding 49. The respective electronics modules 9A, 9B are arranged on the shaft 47 outside the housing 51. Each temperature measurement apparatus 1A, 1B can be identified by a respective identification unit 16 (see FIG. 1). The temperature measured by the respective temperature sensor 7A, 7B is transmitted by each electronics module 9A, 9B by means of an infrared signal 27A, 27B to a common communication unit 21. In this case, the signal 27A, 27B is in each case received, and is passed directly into the receiving area of the communication unit 21 during rotation of the rotor 45. Upstream of the communication unit 21, the signals 27A, 27B are passed out of the housing 51 via a bushing 53 to the processing unit 23. The identification unit 16 is used to identify which of the temperature measurement devices 1A, 1B is associated with the infrared signal 27A, 27B currently being transmitted.

The temperature sensors 7A, 7B withstand both the high voltages in the turbogenerator 41 and the high centrifugal forces, which occur during rotation of the rotor 45. Furthermore, the respective electronics module 9A, 9B is physically separated from the temperature sensor 7A, 7B, so that high temperatures in the electrical rotor winding 49 do not have any damaging effects on the electronics modules 9A, 9B.

The temperature measurement apparatus 1C is arranged on the stator 43. The temperature sensor 7C is in the form of a slot thermometer, and thus measures a winding temperature in a slot in the laminated core of the stator 43. The electronics module 9C is arranged, such that it is separated from the temperature sensor 7C, at a position wherein the voltages and temperatures that occur do not cause any problems. The temperature measured values are transmitted to the processing unit 23 via a bushing 53 through the housing 51. The temperature measurement apparatuses 1D and 1E are likewise arranged on the stator, to be precise shown somewhat enlarged here, on the conductor bars 60, 62 of the end winding 63. The two temperature measurement apparatuses 1D and 1E transmit, together with their respective electronics modules 9D, 9E, to a common communication unit 21D, with a signal association being made via the respective S identification units 16, which are not illustrated in any more detail.

A clock transmitter 64 is disposed on the shaft 47, is connected via a line 66 to the processing unit 23, and is used for synchronization during the transmission of the signals 27.

I claim:

1. In an electrical high-voltage machine having a housing, a temperature measurement apparatus for measuring a temperature within the housing, the apparatus comprising a temperature sensor in the form of a semiconductor chip disposed in the housing.

2. The apparatus according to claim 1, which further comprises an electronics module electrically connected to said temperature sensor.

3. The temperature measurement apparatus according to claim 2, wherein said electronics module is electrically connected to said temperature sensor via a physical distance of not more than one meter.

4. The temperature measurement apparatus according to claim 2, wherein said electronics module has a memory for storing measured values each characterizing one temperature.

5. The temperature measurement apparatus according to claim 4, wherein said electronics module has a microprocessor and a timer, and a timing of a storage of the measured values can be controlled by said microprocessor and said timer.

6. The temperature measurement apparatus according to claim 2, wherein said electronics module and said temperature sensor are physically separated from one another.

7. The temperature measurement apparatus according to claim 2, wherein said electronics module and said temperature sensor are disposed at a spacing distance of at least 10 cm.

8. The temperature measurement apparatus according to claim 2, wherein said electronics module has a transmitting device for wireless transmission of signals.

9. The temperature measurement apparatus according to claim 8, wherein said transmitting device is configured to communicate with infrared radiation.

10. The temperature measurement apparatus according to claim 2, wherein said electronics module has a receiving device for wireless reception of signals.

11. The temperature measurement apparatus according to claim 10, wherein said receiving device is configured to communicate with infrared radiation.

12. The temperature measurement apparatus according to claim 2, wherein said electronics module has a power supply including a solar cell.

13. The temperature measurement apparatus according to claim 2, wherein said electronics module has a power supply configured to utilize inductive generation of electrical power from a magnetic field surrounding said electronics module.

14. The temperature measurement apparatus according to claim 1, wherein the high-voltage machine has a rotor, and said temperature sensor is disposed on the rotor.

15. The temperature measurement apparatus according to claim 1, wherein the high-voltage machine has a rotor carrying an electrical rotor winding, and said temperature sensor is disposed on the rotor winding.

16. The temperature measurement apparatus according to claim 1, wherein the high-voltage machine has a stator winding, and said temperature sensor is disposed on the stator winding.

17. In an electrical high-voltage machine having a housing, a plurality of temperature measurement apparatus for measuring a temperature within the housing, each apparatus comprising a temperature sensor in the form of a semiconductor chip disposed in the housing and an identification unit enabling identification of the respective temperature measurement apparatus, and an evaluation unit for reading each of the temperature measurement apparatus.

18. The temperature measurement apparatus according to claim 1, wherein the high-voltage machine is a turbogenerator.

19. A method of measuring a temperature in an electrical high-voltage machine, which comprises:
determining a temperature in the electrical high-voltage machine as a digital measured value with a semiconductor chip temperature sensor;
transmitting the digital measured value to an electronics module; and
transmitting the digital measured value from the electronics module to an evaluation unit.

20. The method according to claim 19, which comprises strategically disposing a plurality of temperature sensors in the high-voltage machine and reading each of the sensors with an electronics module.

21. The method according to claim 20, wherein the high-voltage machine is a turbogenerator.

22. The method according to claim 19, which comprises storing the measured value in the electronics module.

23. The method according to claim 19, which comprises transmitting the measured value from the electronics module to the evaluation unit without physical contact.

24. The method according to claim 19, which comprises wirelessly transmitting the measured value from the electronics module to the evaluation unit via infrared radiation.

25. The method according to claim 19, which comprises determining a temperature of a stator winding of the high-voltage machine.

26. The method according to claim 19, which comprises determining a temperature of a rotor winding of the high-voltage machine.
